(19) United States
(12) Patent Application Publication
(10) Pub. No.: US 2011/0014059 A1
(43) Pub. Date: Jan. 20, 2011

(54) PRODUCTION METHOD OF A COATING LAYER FOR A PIECE OF TURBOMACHINERY COMPONENT, THE COMPONENT ITSELF AND THE CORRESPONDING PIECE OF MACHINERY

(76) Inventors: Iacopo GIOVANNETTI, Firenze (IT); Riccardo PAOLETTI, Firenze (IT); Massimo GIANNOZZI, Firenze (IT); Eugenio GIORNI, Firenze (IT); Andrea AVANZINI, Firenze (IT)

Correspondence Address: General Electric Company;GE Global Patent Operation, 2 Corporate Drive, Suite 648, Shelton, CT, 06484, US

(21) Appl. No.: 12/835,782

(22) Filed: Jul. 14, 2010

(30) Foreign Application Priority Data
Jul. 15, 2009 (IT) CO2009A000024

(51) Int. Cl. F01D 5/14; B05D 1/18; B21D 53/78

(52) U.S. Cl. 416/241 R; 427/438; 29/889.7

(57) ABSTRACT

A method to produce a turbomachinery impeller, which includes, at least, the following steps: creation of the impeller using a light alloy, and coating of the impeller with a nickel-plating coating.

### CROSS-REFERENCE TO RELATED APPLICATIONS

This application claims priority under 35 U.S.C. §119(a)-(d) or (f) to prior-filed, co-pending Italian patent application serial number CO2009A000024, filed on Jul. 15, 2009, which is hereby incorporated by reference in its entirety.

### BACKGROUND OF THE INVENTION

1. Field of Invention

This invention relates to a production method regarding a coating layer for a turbomachinery component. It also relates to the component itself and the piece of machinery where the component is installed.

2. Description of the Prior Art

Turbomachinery impellers are crucial components because they interact with the process fluids and also because they endure continuous mechanical, chemical and thermal stress.

These components are traditionally produced with “heavy” alloys so that a high degree of durability is ensured during operation.

By “heavy” alloy is usually meant a metal based alloy: the metal has a high atomic number, such as iron, nickel, cobalt etc. Stainless steel and in general all superalloys (having a nickel, cobalt or many other metals as a base), are all heavy alloys.

Usually the component, or the material it is made of, based on the specific use, undergoes mechanical, thermal and/or chemical treatments in order to modify the internal or the superficial structure, or in order to develop a superficial coating which will enhance mechanical, chemical and/or thermal resistance.

Usually a nickel-plating procedure follows to apply a protective coating against “corrosion”.

“Corrosion” can briefly be defined as a typical process during which a metal undergoes an initial degradation which is followed by a recomposition with other elements. Metals are at a higher energetic level than the corresponding minerals and, quite because of this, in specific conditions of the environment, metals are prone to undergo a transformation or degradation called “corrosion”. The corrosion process can be classified based on the different chemical/physical processes that characterise it: for example the chemical corrosion in a dry environment, called “purely chemical corrosion”, or the intercrystalline/intergranular corrosion, or the galvanic/electrochemical corrosion in a wet environment or others thereof

The nickel-plating is a specific superficial treatment which aims at modifying the superficial characteristics of the material which is being processed (such as hardness, resistance to external agents thereof) which allows the deposition of nickel atoms on the surface which needs to be treated.

Nickel coating has a very low porosity and consequently the process described above firmly seals the base material in order to preserve it from the aggression of external agents, avoiding corrosion.

Therefore, the protective capacity against corrosion of the coating is good, even if it also depends on the type of metal on which it is applied, depending on the specific porosity, roughness and surface condition of the metal; a high concentration of phosphorus (chemical symbol “P”), exceeding 10%, seems to enhance the resistance against corrosion.

It is also possible to perform a thermal treatment (annealing) on the coated part, to increase its hardness and wear resistance, in this last case, though, the resistance against corrosion decreases. A major drawback linked to the use of nickel-plating to coat the centrifugal impellers of pieces of turbomachinery is that these impellers undergo radial expansions, due to the centrifugal force, when in use. Therefore the nickel coating might dilate creating small cracks or fractures in which the corrosion process might start.

While a new family of tridimensional centrifugal impellers in steel was being developed, the necessity to use lighter alloys to build them arose, especially in some applications, in order to reduce production costs and to enhance the performance and mechanics of the machinery on which they can be fitted.

Another interesting improvement is the increase in rotational speed of the same impellers when using materials having a higher specific resistance than steel: both titanium and aluminium as well as magnesium based light alloys have this characteristic due to their low density.

One of the main disadvantages in using these lighter alloys to fabricate centrifugal impellers is that they are subject to be eroded by the fluid which, flowing at high speeds, can cause the erosion, especially if the fluid contains liquid or solid particles. The erosion, usually not significant in case of impellers made from the traditional heavy alloys, becomes very significant and potentially catastrophic for impellers in light alloy, due to the low hardness and resistance to erosion which characterise these materials.

The damage is also worsened by the rotational speed of the impellers, the higher the speed, the stronger the erosion: this problem limits the use of light alloys, such as aluminium, to build impellers having a high rotational speed.

“Erosion” can briefly be defined as a phenomenon which entails the gradual removal of material performed by gas, fluid or liquid external agents, which can act jointly or after an alteration generated by chemical or physical processes. “Abrasion” can also be defined as a specific eroding phenomenon which entails the gradual removal of material performed by solid external agents.

A further difficulty is that the coatings for centrifugal impellers must also, in general, be “machineable” in the easiest and smoothest way to limit production costs. By “machineable” it is meant their capability to be developed through specific devices (electrochemical baths or others), which, when applied, will completely coat the surfaces of the complex geometrical shapes of the impellers; this applying especially to tridimensional closed impellers. Furthermore, these coatings will have to ensure a high superficial hardness to ensure the resistance and the preservation of the coating itself for long operational periods and also ensure resistance against the eventual impact of foreign bodies.

Another downside is that the deposition of the coating layers must be carefully controlled to ensure project tolerances and at the same time to avoid unacceptable faults in the finished product, such as stains, coating delamination and failures, to remain within the border values typical for the specific coating.

Thus, at this moment, still withstanding the progresses made by technology, it is problematic and necessary to fabricate turbomachinery centrifugal impellers which will be lighter and more resistant to adapt to specific applications but which, at the same time, need to ensure at least the same resistance against solid particles and liquid drops erosion as the one ensured by “heavy” alloys.

### SUMMARY OF THE INVENTION

One purpose is the creation of a method aimed at producing a turbomachinery impeller in a simple and cost effective way, thus overcoming, at least partially, the above mentioned issues.

Another purpose is to fabricate an impeller with better specifications and a piece of turbomachinery where the impellers will be mounted.

A specific purpose is also to use a specific coating which will eliminate some of the drawbacks mentioned above, creating, at the same time, a finished product having better specifications than the ones currently used.

In practice these purposes can be achieved through a method as claimed below.

The technical advantages of this invention are listed in the Claims listed below.

An aspect of this invention is to set a method to produce a turbomachinery impeller which will at least include the following steps:
fabricate a “light” alloy impeller,
coat the impeller with at least one layer of nickel-plated coating.

All throughout the document and the Claims attached a “coating layer” will mean a coating layer which will incorporate intermediate layers or to which more intermediate layers will be added; thus, the coating will incorporate many layers one on top of the other which will at least partially penetrate into one another.

A “light” alloy will mean an alloy having a metal base which has a low atomic number, such as aluminium, titanium, magnesium etc.

A very convenient application of the invention is the one in which the light alloy is aluminium based, depending on the specific use.

In the application which better fits this invention, the nickel-plating will be made through “chemical nickel plating”.

A “chemical nickel plating” is, generically, a process which uses the direct action of a reducing agent in a process bath on nickel ions which will be deposited and which will activate a nickel chemical reduction autocatalytic process; such reduction is caused by sodium hypophosphite (NaH₂PO₂×H₂O). The mechanical component, immersed in the process bath, will serve as a catalyst. Such deposition can be achieved on any material (even if not an electrical conductor) being it metal, glass, ceramic or plastic.

In particular, and considering the main reagents in the process bath, the following chemical relation can be established:

H₂PO₂₋+H₂O→H₂PO₃₋+H₂ (1)

Ni₂₊+H₂PO₂₋+H₂O−>Ni+H₂PO₃₋+2H+

The hypophosphite ions in an aqueous solution are catalytically oxidised to become phosphite ions releasing gaseous hydrogen and at the same time the nickel cations are catalytically reduced to nickel metal by the hypophosphite ions in the presence of water, while the hypophosphite ions are oxidised and become phosphite ions releasing, at the same time, hydrogen ions. Being the nickel a catalyst both for the first and for the second chemical reaction, the process is “self-triggered”.

The process bath might include more elements or substances depending on the specific application, such as, for example, organic chelants, buffer solutions, exciting agents, stabilising agents, pH regulators or wetting agents in order to achieve an acid or alkaline bath, or a fluoride based or ammonia based bath, or others thereof

This procedure allows the production of a nickel coating with a constant thickness (which eliminates the need of correction after deposition) regardless the geometrical shape of the part, thus avoiding the typical drawbacks involved in electrolytic procedures.

In a very convenient application of this invention, this layer of coating protects the impeller in light alloy, aluminium alloy and others, from erosion. In this case the nickel plating is applied on impellers used in pieces of turbomachinery which include process fluids at a high risk for causing erosive phenomena, such as gasses with liquid or solid particles in suspension.

The invention might be used in industrial applications such as gas and oil extraction sites, because the gasses which gush from the well might contain liquid or solid particles.

Further benefits of the chemical nickel plating performed on a light alloy impeller, especially if aluminium based, but not exclusively, arise from the fact that the adherence of the coating on the base material, the hardness and the wear resistance are outstanding; it is also possible to enhance the hardness of the coated part performing further treatments (for example, a thermal annealing or others thereof) which will increase the resistance of the component against erosion.

According to another aspect, the invention can be seen as the creation of a turbomachinery impeller in light alloy coated with at least one layer of a protective nickel coat, preferably chemical nickel plating.

A further aspect sees the invention as regarding a piece of turbomachinery where at least one impeller of the same type as the ones described above is mounted.

An additional aspect sees the invention as regarding the use of a layer of coating as the ones described above, to protect at least partially from the erosion an impeller in light alloy, especially if aluminium based, but not necessarily, of a piece of turbomachinery.

An advantage of the method implemented in the invention is that it becomes possible to coat a light alloy mechanical component using a protective coating in a simple and cost effective way, so that it will be possible to effectively mount it on a piece of turbomachinery, especially if the fluids involved in the process are highly erosive.

Another advantage entailed is that it becomes possible to easily coat a component which has a very complex surface to be treated, such as, for example, the one of a tridimensional impeller of a centrifugal compressor or of an expander.

Another advantage is that producing the centrifugal impellers in a light alloy, significantly reduces the mass of the component, decreasing the mechanical stress and the vibrations in the rotor of the machine. Further advantages deriving from mass reduction are the increase of the number of turbomachinery stages and/or the increase of rotational speed.

Another advantage is that costs and production times are exceptionally lower, thus enhancing productivity.

Another advantage is that the high quality manufacture, due to the fact that nickel deposition is easily manageable, is extremely even and delivers a constant thickness.

Another advantage arises from the fact that the method is very versatile, because it can be implemented through automated processes in combination with possible partial manufacturing work, such as painting or others thereof

Another advantage is that it becomes easy to obtain a finished component having the theoretical fluid dynamics studied in the project, eventually keeping into account specific superficial increase coefficients.

Ultimately, the invention described above, allows the use of light alloys, especially if aluminium based, to fabricate impellers for centrifugal compressors or expanders enjoying the advantages listed above. Further convenient specifications and ways to produce the invention are indicated in the attached Claims and will be described further below in a few examples indicating possible applications.

### BRIEF DESCRIPTION OF THE DRAWINGS

The numerous purposes and advantages of this invention will be more evident for the experts in this field if they refer to the schematic drawings attached, which show practical non restrictive examples.

In the drawing:

FIG. 1 shows a schematic section, not drawn to scale, of a possible realisation of a protective coating following the procedure described in the invention;

FIG. 2 shows a section view of a mechanical component showing a protective coating, fabricated following the procedures described in the invention;

FIG. 3 shows a schematic section of a piece of turbomachinery on which the mechanical components described in the invention were mounted;

FIG. 4 shows an explanatory graph of the results of some erosion tests performed on a set of samples, some of them coated with the procedures described in the invention, others with commercial alloys to confront them.

### DETAILED DESCRIPTION OF THE INVENTION

In the drawings, (to equal numbers correspond equal parts in all of them), a coating 1, as indicated in the invention, please see FIG. 1, is applied through chemical nickel plating on the surface to be treated 3S belonging to a centrifugal impeller 3 made out of light alloy.

The impeller can be of any kind, such as, for example centripetal, mixed flow or others.

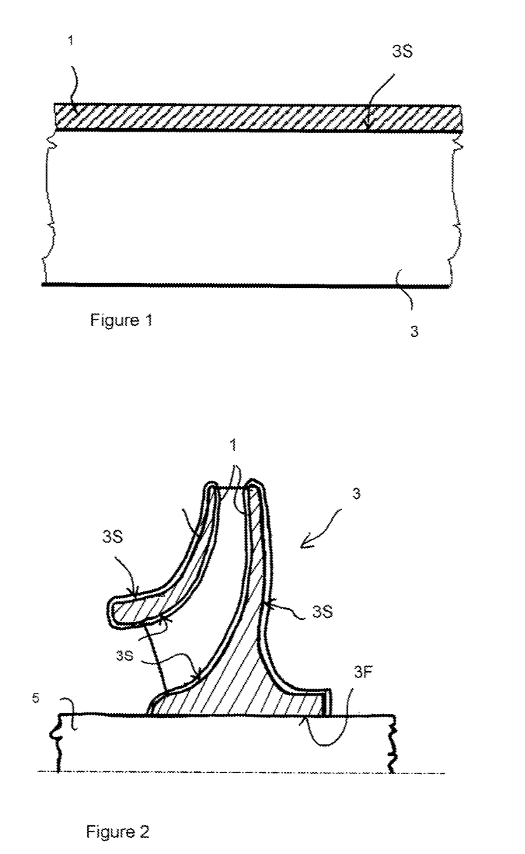

FIG. 2 shows a partial section, not drawn to scale, of a centrifugal impeller 3 for a centrifugal compressor, coated with the above mentioned coating 1 as indicated in the invention and mounted on a shaft 5: please note that the surface 3S of the impeller 3 is both external and internal (internal channels), exception made for the hole 3F in which the shaft 5 is mounted.

In particular, the impeller 3 drawn in the picture is a three dimensional closed impeller; obviously the impeller could be of any other type, an open three dimensional impeller for example, or a closed two dimensional impeller or an open one or any other type.

Please note that FIGS. 1 and 2 and not drawn to scale and that the thickness of layer 1 was drawn only for explanatory reasons.

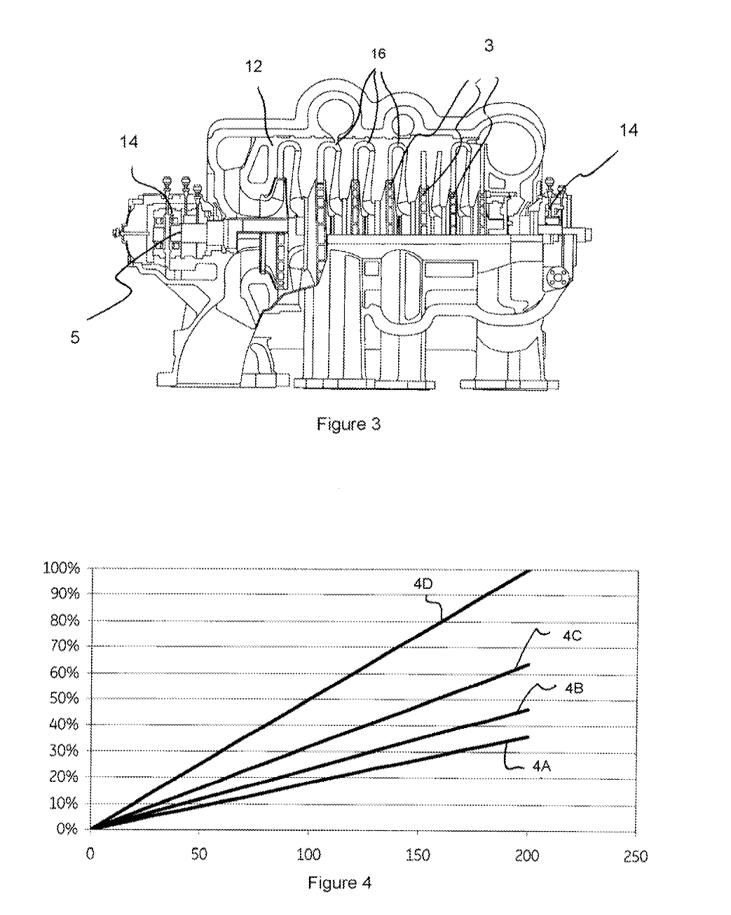

FIG. 3 shows schematically a generic centrifugal compressor 10 which includes a stator box 12 inside of which the shaft 5 is free to rotate; the shaft rests on a set of bearings which offer support 14 and on which a series of centrifugal impellers 3 were mounted. The impellers have been coated 1, and each one of them is mounted for each stage of the compressor 10. On the box stator channels were carved 16 which allow the process fluid to reach the exit of the first impeller towards the second one of the next stage and so on, until the fluid will exit the machinery from the compressor 10.

Please note that this compressor is just an example, and that the invention can be used in another type of centrifugal compressor or in another centrifugal piece of turbomachinery, such as a pump or an expander or other types of devices. To lay the protective coating 1 the procedure conveniently suggests immersing the impeller 3 in a process bath containing an aqueous solution of reagents.

The chemical baths may contain at least the following reagents: nickel salts, sodium hypophosphite reducers mixed with an aqueous solution. The reaction is triggered spontaneously as soon as the impeller is immersed in the bath and slowly the impeller 3 will start being covered with the thin layer 1 in nickel.

It is possible to set the thickness of the coating, preferably from 50 to up to 100 microns or more, properly regulating the duration of the immersion of the impeller in the bath (once the deposition speed is known).

It is also possible to apply more layers on the nickel one, such as paints or resins or other similar products depending on the specific application.

It is also possible to use specific elements or substances, such as tungsten carbide, DLC, chrome carbides, lactic acid or others, dissolved in the chemical bath based on the specific application.

It is possible to prepare the surface of the impeller 3 for the following treatments implementing a few preliminary treatments, such as shot peening to reduce the tension and enhance the strain resistance of the material; degreasing of the impeller with solvents or detergents or vapour or immersing the part to perform chemical degreasing treatments; masking of areas of the surface which will not be coated, for example the hole in which the shaft will be mounted, or other treatments thereof.

In the most convenient application of the invention, the light alloy which the mechanical component 3 is made of is an aluminium based alloy.

The following tables indicate, as an example, the composition of the aluminium alloys 7175-T74 and 7050-T7452 (following the definition of the international regulations ASTM B 247 M) which can be used to produce component 3; obviously this is just an example and the light alloy specifications can differ both in the percentages and in the components used.

| Composition (ASTM B 247 M) | Min % | Max % |
|---|---|---|
| Aluminium Al | 87.82 | 91.42 |
| Chromium Cr | 0.18 | 0.28 |
| Copper Cu | 1.20 | 2.00 |
| Iron Fe | | 0.20 |
| Magnesium Mg | 2.10 | 2.90 |
| Manganese Mn | | 0.30 |
| Silicon Si | | 0.10 |
| Titanium Ti | | 0.10 |
| Zinc Zn | 5.10 | 6.10 |
| Others (each) | | 0.05 |
| Others (Total) | | 0.15 |
| | Aluminium alloy | |
| | 7175-T74 | |

| Composition (ASTM B 247 M) | Min % | Max % |
|---|---|---|
| Aluminium Al | Bal. | Bal. |
| Chromium Cr | — | 0.04 |
| Copper Cu | 2.00 | 2.60 |
| Iron Fe | — | 0.15 |
| Magnesium Mg | 1.90 | 2.60 |
| Manganese Mn | — | 0.10 |
| Silicon Si | — | 0.12 |
| Titanium Ti | — | 0.06 |
| Zinc Zn | 5.70 | 6.70 |
| Others (each) | — | 0.05 |
| | Aluminium alloy | |
| | 7050-T7452 | |

FIG. 4 shows an explanatory graph of the results of some erosion tests performed following the standard indicated by the regulations ASTM D 968-93 on several samples, in which: the X-axis indicates the quantity of sand used in litters and the Y-axis indicates the thickness of the eroded sample, based on normalised values (where 100% indicates the maximum erosion value obtained in the test).

In particular, the line 4A shows the results of the test for a sample in an alloy a in steel without coating; line 4B shows a sample made of an aluminium based alloy coated with a layer as indicated in the invention; line 4C shows a sample in an aluminium based alloy coated with a layer of hard anodisation which is Typically used to coat aluminium and the fourth line 4D shows a sample of an aluminium based alloy without coating.

Please note that in this graph the sample made of aluminium based alloy without coating, shows resistance values against erosion caused by solid particles which is significantly lower than the one of steel; please also note how, after the application of the coating, as indicated by the invention, it is possible to give the aluminium a resistance to erosion which is similar to the one of steel and much higher than the hard anodisation coating applied on aluminium to enhance hardness.

It is agreed that the illustration is only an indication and that it does not, in any way, limit the possibilities of the invention, which can vary in form and ways always being pertinent to the foundation at the base of the invention itself. The possible presence of ref. numbers in the attached Claims has the only aim to make reading easier both when related to the previous text and when referring to the attached drawings, and does not limit, in any way, the scope of protection.

1. A method of fabricating an impeller for turbomachinery, the method comprising:
forming the impeller from a light alloy; and
coating the impeller with at least one layer comprising nickel.

2. The method as claimed in claim 1, wherein coating the impeller with the at least one layer comprises chemical nickel-plating.

3. The method as claimed in claim 1 wherein coating the impeller with the at least one layer further comprises immersing the impeller in a process bath that comprises sodium hypophosphite ions in aqueous solution.

4. The method as claimed in claim 3, adding to the process bath at least one of organic chelants, buffer solutions, exciting agents, stabilising agents, pH regulators and wetting agents, based on a specific application in which the impeller is to be used.

5. The method as claimed in claim 1, wherein the light alloy comprises at least one of aluminium, titanium, magnesium and any light metal based alloy.

6. An impeller for turbomachinery, comprising:
a light alloy; and
a coating comprising at least one layer comprising nickel.

7. The impeller as claimed in claim 6, wherein the impeller is associated to a piece of turbomachinery which operates using a process fluid which triggers erosive phenomena, such as a gas containing liquid or solid particles.

8. A piece of turbomachinery comprising at least one centrifugal impeller according to claim 6.

9. A method for protecting an impeller for turbomachinery comprising applying a layer of a chemical nickel coating to the impeller, wherein the impeller comprises a light alloy, selected from a group comprising aluminium, titanium, magnesium and any other light metal based alloy.
